(19) United States
(12) Patent Application Publication
(10) Pub. No.: US 2010/0068084 A1
(43) Pub. Date: Mar. 18, 2010

(54) MODULAR COMPRESSOR-VALVE DESIGN FOR REFRIGERANT SYSTEM

(76) Inventor: Alexander Lifson, Manlius, NY (US)

Correspondence Address: CARLSON, GASKEY & OLDS, P.C., 400 WEST MAPLE ROAD, SUITE 350, BIRMINGHAM, MI, 48009, US

(21) Appl. No.: 12/374,527

(22) PCT Filed: Aug. 1, 2006
(86) PCT No.: PCT/US06/29816

§ 371 Date: Jan. 21, 2009

(51) Int. Cl. F04B 39/08; F04B 39/00; B23P 19/04

(52) U.S. Cl. 417/505; 417/437; 29/700

(57) ABSTRACT

A compressor-valve modular design provides manufacturing simplicity, reduces applied cost, and improves quality and reliability of a refrigerant system. In this design, a valve is preferably an electronically controlled valve having a control member that controls the flow of a fluid through the valve. A discharge valve, a stepper motor modulation valve, an economizer vapor injection valve, a liquid injection valve or any combination of thereof are the examples of the valves within the compressor-valve subassembly.

### BACKGROUND OF THE INVENTION

This application relates to a method and system wherein a compressor-valve modular design is implemented to provide manufacturing simplicity, reduce applied cost and improve quality and reliability. In particular, this application relates to a refrigerant system wherein performance enhancement features are implemented and associated with (and adjacent to) at least one of the compressor ports.

Refrigerant systems are known and utilized to condition a secondary fluid to provide comfort in an indoor environment. As an example, an air conditioning system cools and dehumidifies air being delivered into an indoor environment.

Conventional refrigerant systems generally include a compressor compressing refrigerant and delivering that refrigerant through a discharge line to a downstream heat exchanger, so-called a condenser. From this first downstream heat exchanger, refrigerant passes through an expansion device and then through a second heat exchanger, so-called an evaporator. The refrigerant is then returned to the compressor.

Beyond this very basic refrigerant system description, any number of optional features can be incorporated to either improve system performance and reliability or extend a spectrum of potential applications. As an example, to provide certain control features, such as a prevention of undesirable backflow of refrigerant from a high pressure location to a lower pressure location within the refrigerant system after compressor shutdown, a controlled discharge valve can be placed on a discharge line. Similarly, a modulation valve can be placed on a suction line communicating the second heat exchanger back to the compressor for the refrigerant system capacity control.

Another optional feature is an economizer vapor injection cycle. In an economizer cycle, a flow of refrigerant is tapped off from a main flow downstream of the first heat exchanger. The tapped flow is passed through an auxiliary expansion device that causes the refrigerant to expand to a lower pressure and temperature. This tapped refrigerant is then passed through an economizer heat exchanger for heat transfer interaction with the main refrigerant flow. The tapped refrigerant flow cools the main flow. The tapped flow is typically returned through an economizer line to the compressor at an intermediate compression point. Again, a vapor injection valve controls the flow of this refrigerant being returned to the compressor. Analogously, a liquid injection feature can be employed, where a liquid is injected either into compressor suction or into intermediate compression stage. To control the liquid injection, a valve is normally employed to turn the liquid injection function on and off.

In the prior art, each of these several valves associated with the compressor has been independently produced and implemented within the refrigerant system. The independent implementation of these valves into the system often required additional assembly during system manufacturing and could be a source for mistakes and unnecessary complexity.

### SUMMARY OF THE INVENTION

In a disclosed embodiment of this invention, a compressor-valve modular subassembly is implemented to provide manufacturing simplicity, reduce applied cost and improve quality and reliability for a refrigerant system where performance enhancement features are desired and associated with at least one valve adjacent to at least one compressor port. Within this subassembly design, a valve is preferably an electronically controlled valve having a control member that controls the flow of a fluid from the valve inlet line to the valve outlet line. As an example, the valve can be utilized as a discharge valve, a suction modulation valve, an economizer vapor injection valve, a liquid injection valve or any combination of thereof. Valves can be solenoid valves or motor-driven modulation valves. Further, a function of two valves can be combined into a three-way valve. The valves are located outside of the compressor shell. The compressor shell normally surrounds the internal compression elements within the compressor. The compressor shell can be a so-called welded compressor shell or a cast iron compressor shell, which is typical, for instance, for screw or reciprocating compressors.

In this manner, a relatively inexpensive compressor-valve subassembly is produced, manufacturing complexity is reduced, enhancement features are implemented and refrigerant system quality and reliability are improved.

These and other features of the present invention can be best understood from the following specification and drawings, the following of which is a brief description.

### BRIEF DESCRIPTION OF THE DRAWINGS

FIG. 1 is a schematic view of a refrigerant system.

FIG. 2 shows a first location of the valve within a compressor-valve modular subassembly.

FIG. 3 shows another location of the valve within a compressor-valve modular subassembly.

FIG. 4 shows yet another location of the valve within a compressor-valve modular subassembly.

FIG. 5 schematically shows a method according to the present invention.

### DETAILED DESCRIPTION OF THE PREFERRED EMBODIMENTS

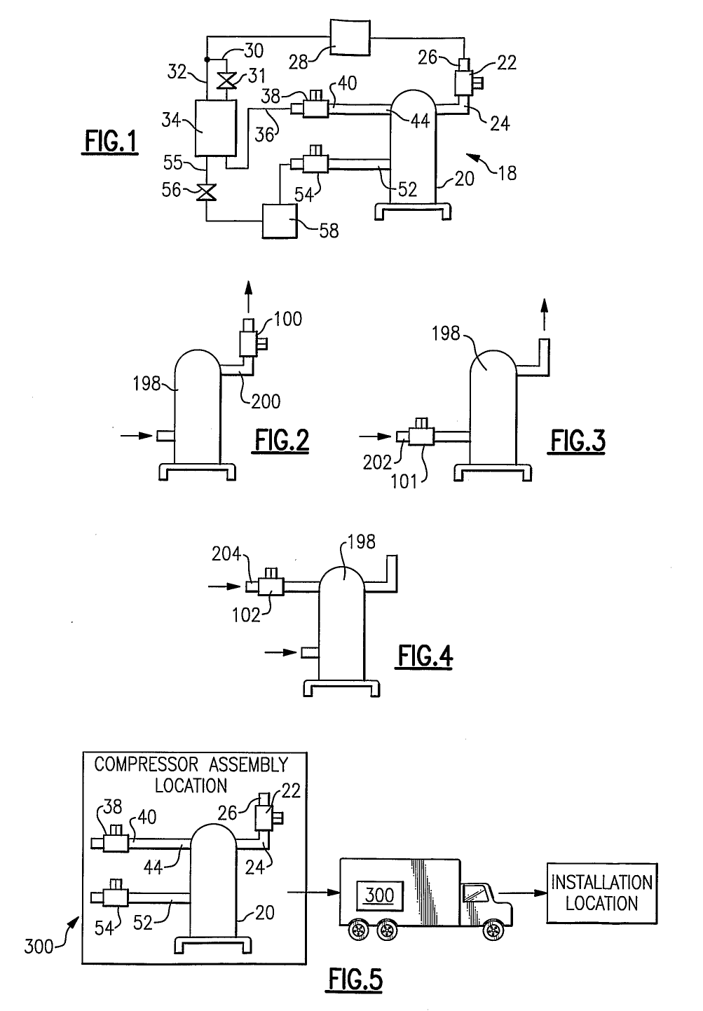

A refrigerant system 18 illustrated in FIG. 1 incorporates a compressor 20. The compressor 20 delivers a compressed refrigerant to a downstream discharge valve 22, and through a discharge line 24. Discharge valve 22 is typically used to prevent a backflow of refrigerant during shutdowns of the compressor 20, or can be utilized as a discharge pressure regulator. This valve can be electronically controlled. Refrigerant flowing from the discharge line 24 through the valve 22 passes into a downstream line 26 that delivers the refrigerant flow to a condenser 28. When the compressor is shutdown, the valve 22 blocks the refrigerant from passing from the condenser 28 into the compressor 20 and then into an evaporator 58. A tap line 30 taps refrigerant from a liquid line 32 downstream of the condenser 28. The tap line 30 passes through an economizer auxiliary expansion device 31. The tapped refrigerant in the tap line 30 and the liquid refrigerant in the liquid line 32 both pass through an economizer heat exchanger 34. While the two refrigerant streams are shown flowing in the same direction, in practice, it is often preferable to have the two flows arranged in a counterflow configuration. The tapped refrigerant in the tap line 30, having cooled the refrigerant in the liquid line 32 in the economizer heat exchanger 34, is directed to a line 36 toward the compressor 20. A vapor injection valve 38 can shut off the flow of this returned vapor refrigerant. The vapor injection valve 38 is connected to a downstream return line 40. Analogously, a liquid injection valve can be employed, in case an economizer heat exchanger is not present or is bypassed. Liquid injection is typically used to cool the compressor and may or may not share the same port with the vapor injection function. Refrigerant passing through the dedicated liquid injection line can be injected either into the compressor suction or directly into the compression process, as known.

The suction line 52 can have an optional motor driven modulation valve (suction modulation valve) 54. The main refrigerant flow, having passed through the economizer heat exchanger 34, passes into a line 55, through a main expansion device 56, to the evaporator 58, and through the suction modulation valve 54 to a suction line 52. Suction modulation valves are usually used to provide capacity control for the refrigerant system 18. The suction modulation valve 52 can also be used in refrigerant systems that are not equipped with economized cycles.

Each of the valves 22, 38, and 54 can be controlled by an electronic control for the refrigerant system 18 and could be of an identical design. Any of these valves can, for example, be a solenoid valve or Motor driven modulation valves.

FIG. 2 shows a modular compressor-valve subassembly with a compressor 198 having its discharge line 200 receiving the discharge valve 100. The discharge valve 100 is typically utilized to block the refrigerant backflow during the compressor shutdowns, or is utilized as a discharge pressure regulator.

FIG. 3 shows a modular compressor-valve subassembly with the compressor 198 having a suction line 202 receiving a suction modulation valve 101. The suction modulation valve 101 is generally used to control system capacity.

FIG. 4 shows a modular compressor-valve subassembly with the compressor 198 having a vapor or liquid injection line 204 receiving a vapor or liquid injection valve 102. The valve 102 is commonly employed to inject liquid (to cool the compressor) or vapor (for an economizer cycle) into intermediate point in the compression process. As mentioned above, liquid injection and vapor injection ports do not necessarily coincide.

It should also be pointed that other valve arrangements are possible where, for example, a valve may provide a fluid connection between the fluid lines attached to the compressor. In this case the valve can selectively isolate higher pressure compressor port from lower pressure compressor port.

Although preferred locations for the use of the valves are disclosed, other arrangements or a combination of the abovementioned arrangements may also be utilized. A compressor-valve design as a modular subassembly, where the associated valves are an integral part of the compressor, provides manufacturing simplicity, reduces applied cost and improves quality and reliability for a refrigerant system where performance enhancement features are desired and associated with at least one valve adjacent to at least one compressor port.

In contemporary applications, since refrigerant systems operate at a wide spectrum of environmental conditions, exposed to a variety of thermal load requirements and, as a result, have multiple enhancement features; many valves are implemented to invoke this functionality and are associated with the compressor. Consequently, it is beneficial for the manufacturing simplicity to preassemble a module consisting of a compressor and associated valves. In this case, this module will have strictly defined interfaces to other system components and allow for a more compact design and reduced cost, due to a modular design concept. Also, utilizing preassembled module, the chance of a defect is reduced or would surface early enough in the manufacturing process, consequently improving quality and reliability.

As shown in FIG. 5, a modular compressor 20 and valving system subassembly 300 can include any one or all of the valves 100, 101, 102, and as mentioned, other valves, as a modular subassembly. This modular subassembly 300 can be manufactured at a compressor assembly plant, where more skilled technical assembly workers are available. That modular compressor and valving system subassembly 300 can then be shipped to a location where the refrigerant system 18 is to be assembled. As mentioned above, by providing the modular subassembly, benefits with regard to simplicity of a final assembly are achieved.

Within this subassembly design a valve is preferably an electronically controlled valve having a control member that controls the flow of a fluid from the valve inlet line to the valve outlet line. The inlet and outlet lines to the valve can be provided with inserts or adapters such that, if the same valve is utilized, it can be connected to refrigerant lines of various sizes. Further, by utilizing a common modular valve, the cost for designing, manufacturing, implementation, etc., of the valves is reduced even further, as compared to the prior art. This makes the use of the several optional refrigerant system enhancement functions, as disclosed in this application, to become more practical and affordable. It should be noted that this invention is applicable to many different compressor types, for example, including scroll compressors, reciprocating compressors, screw compressors, rotary compressors, and reciprocating compressors. Other compressor types would obviously fall within the scope of this invention as long as there is a compressor and a valve comprising an integral module. This invention is also applicable to a broad range of applications, for example, including container and truck-trailer refrigeration units, room and residential air conditioning units, commercial refrigeration and air conditioning systems, automotive air conditioning, and rooftop installations and chillers.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A refrigerant apparatus, comprising:
a compressor having a compressor shell and at least two compressor ports; and
at least one valve, fluidly connected to said at least one compressor port outside of said compressor shell to enhance compressor functionality within a refrigerant system, wherein said valve and said compressor comprising an integral module.

2. The refrigerant apparatus as set forth in claim 1, wherein said at least one valve is fluidly connected to a discharge port of said compressor.

3. The refrigerant apparatus as set forth in claim 1, wherein said at least one valve is fluidly connected to a suction port of said compressor.

4. The refrigerant apparatus as set forth in claim 1, wherein said at least one valve is fluidly connected to a liquid injection line of said compressor.

5. The refrigerant apparatus as set forth in claim 1, wherein said at least one valve is fluidly connected to a vapor injection port of said compressor.

6. The refrigerant apparatus as set forth in claim 1, wherein said at least one valve is an electrically controlled valve.

7. The refrigerant apparatus as set forth in claim 6, wherein said electrically controlled valve is a solenoid valve.

8. The refrigerant apparatus as set forth in claim 6, wherein said electrically controlled valve is a stepper motor modulation valve.

9. A method of assembling a refrigerant system comprising the steps of:
1) providing a modular subassembly of a compressor and an associated at least one valve mounted outwardly of a shell for said compressor, said modular subassembly being manufactured at a first location; and
2) transporting said modular subassembly to a final assembly location where a refrigerant system is being assembled, and connecting said modular subassembly to a refrigerant system.

10. The method as set forth in claim 9, wherein said at least one valve is fluidly connected to a discharge port in said compressor.

11. The method as set forth in claim 9, wherein said at least valve is fluidly connected to a suction port in said compressor.

12. The method as set forth in claim 9, wherein said at least one valve is fluidly connected to a liquid injection line in said compressor.

13. The method as set forth in claim 9, wherein said at least one valve is fluidly connected to a vapor injection line in said compressor.

14. The method as set forth in claim 9, wherein said at least one valve is an electrically controlled valve.

15. The method as set forth in claim 14, wherein said electrically controlled valve is a solenoid valve.

16. The method as set forth in claim 14, wherein said electrically controlled valve is a stepper motor modulation valve.
